(19) United States
(12) Patent Application Publication
(10) Pub. No.: US 2001/0047039 A1
(43) Pub. Date: Nov. 29, 2001

(54) Cationic emulsifier-enhanced liquid crystal gel network based skin care moisturizing compositions

(76) Inventors: Richard L. McManus, Shelton, CT (US); Himanshu Trivedi, Bridgeport, CT (US); Bryan P. Murphy, Monroe, CT (US); Eric Spengler, Ridgefield, CT (US)

Correspondence Address: Charles J. Zeller, Esquire, 2 Blachley Road, Stamford, CT, 06922, US

(21) Appl. No.: 09/825,467

(22) Filed: Apr. 2, 2001

Related U.S. Application Data
(60) Provisional application No. 60/196,640, filed on Apr. 12, 2000.

(51) Int. Cl. C09K 3/00

(52) U.S. Cl. 516/98

(57) ABSTRACT

The present invention relates to skin moisturizing compositions comprising a liquid crystal/gel network (LCGN) emulsion system comprising water, cationic emulsifiers, low HLB emulsifiers and emollients. In one aspect, the compositions comprise an emollient component as an occlusive agent, such as a petroleum-derived or a non-petroleum-derived occlusive agent, in the LCGN emulsion system. Additives such as adjuvants, active agents, or excipients may also be included in the compositions of the invention. The compositions of the present invention provide excellent moisturization and improved aesthetics (faster absorbency with more pleasant afterfeel properties) compared with traditionally available moisturizing products having different compositions and components and containing petroleum and/or mineral oil, to which are attributed greasiness and other unpleasant, user-perceived attributes.

### FIELD OF THE INVENTION

The present invention relates to skin moisturizing compositions that are especially effective to provide moisture to dry and extra dry skin. These compositions comprise a liquid crystal/gel network (LCGN) emulsion system, comprising water; at least one cationic emulsifying agent; at least one low HLB emulsifying agent; and, optionally, at least one emollient.

### BACKGROUND OF THE INVENTION

Personal moisturizing compositions are widely used by consumers and must satisfy multiple criteria to be acceptable to consumers. These criteria include relieving and preventing skin dryness (by hydrating the skin or occluding the skin with water-insoluble materials), imparting a soft or smooth feeling to the skin, and mildness. Ideal personal moisturizer compositions should relieve and prevent dry skin, cause little or no irritation, and leave an aesthetically pleasant afterfeel.

Commercially available skin moisturizing compositions, while exhibiting adequate moisturization, have slow absorbency and poor afterfeel characteristics, such as greasiness, waxiness and drag. These negative attributes can be considered to be cosmetically unacceptable to the consumer. Thus, it is highly desirable to develop effective skin moisturizing compositions that not only have improved moisturization, but also faster absorbency and improved afterfeel characteristics versus traditional compositions.

Oil-in-water emulsions whose stabilization is provided by a lamellar liquid crystal three-dimensional network can be referred to as a liquid crystal/gel network or “LCGN” emulsions (Junginger et al., JSCC, Vol. 35:45-57 (January, February 1984). Suzuki et al. (“Secondary droplet emulsion: Contribution of liquid crystal formation to physicochemical properties and skin moisturizing effect of cosmetic emulsion”, 12^{th} International Congress IFSSC, Paris September 1992, Abstracts, Vol. I, 117-136), describe these oil-in-water emulsions (i.e., LCGNs) as forming superstructures (“secondary droplets”), comprising aggregates of oily droplets coated with liquid crystal lamellae. The authors show that the existence of these superstructures is dependent on the presence of a fatty alcohol. The main qualities of this type of emulsion are the stability with respect to the release of oil and a skin moisturizing effect.

U.S. Pat. No. 5,744,062 to G. H. Dahms et al. discloses emulsifier blends providing stable oil-in-water emulsions of preselected viscosity, with the emulsifier blend containing an acyl lactylate as the primary emulsifier and a nonionic surfactant as the coemulsifier. Dahms (Cosmetics and Toiletries, Vol. 101, November 1986), also describes emulsions, i.e., LCGNs, having stability and skin moisturizing effects. Other LCGNs are disclosed in U.S. Pat. Nos. 5,744,062; 5,658,575; 5,674,509; and 5,641,493. U.S. Pat. No. 5,849,315 to M. Rerek et al. discloses skin care formulations containing emulsifier compositions in the form of LCGNs to prevent the loss of skin lipids. Copending patent application U.S. Ser. No. 09/428,313, filed Oct. 28, 1999, discloses skin moisturizing compositions comprising a liquid crystal gel network and an oil controlling agent.

The present invention described herein provides new and distinctive cationic emulsifier-enhanced liquid crystal gel network-based skin care moisturizing compositions having improved aesthetic and sensory properties for the user.

### SUMMARY OF THE INVENTION

The present invention relates to improved skin care compositions in the form of LCGN emulsions, for example, creams and lotions. Use of the compositions of the present invention results in excellent moisturization coupled with improved absorbency and afterfeel aesthetics to the user.

More particularly, the present invention is directed to personal skin moisturizer compositions comprising water, at least one cationic emulsifier (as a primary emulsifier) and at least one low hydrophilic lipophilic balance (HLB) emulsifier having an HLB of 1 to about 6 or less (as a co-emulsifier or secondary emulsifier) to form an LCGN-based emulsion, and, optionally, one or more emollients, with oil phase emollients being preferred. Thus, in accordance with the present invention, the one or more cationic emulsifiers and the one or more low HLB co-emulsifiers which form the LCGN-based emulsion system can deliver one or more cosmetically acceptable emollients to the user, resulting in a skin care product having improved moisturization, faster absorption into the skin, less greasiness, less waxiness, and fewer unpleasant aesthetic characteristics versus traditional compositions that are currently available. These attributes of the compositions of the present invention provide improved and advantageous organoleptic properties to the final skin care products of the invention. By organoleptics is meant, in general, sensory attributes, such as tactile thickness, spreadability, absorbancy, smell, feel, tackiness, greasiness, waxiness and drag.

In accordance with the present invention, the compositions more specifically comprise water, at least one cationic emulsifier (e.g., as a primary emulsifier), at least one low HLB emulsifier having an HLB of 1 to about 6 or less (e.g., as a co-emulsifier or secondary emulsifier) forming an LCGN-based emulsion system, and at least one emollient, or a component of the composition having emollient properties. The ratio of cationic emulsifiers to low HLB emulsifiers is preferably about 1:1 to 1:25 in the compositions described herein.

### DETAILED DESCRIPTION OF THE INVENTION

The personal moisturizing compositions of the present invention satisfy multiple criteria for the satisfaction and acceptance of consumers. These criteria include relieving and preventing skin dryness (by hydrating the skin or occluding the skin with water-insoluble materials), imparting a soft or smooth feeling to the skin, and mildness. In addition, the present skin care compositions cause little or no irritation, and leave an aesthetically pleasant afterfeel with little or no greasiness, waxiness or drag. Typically, these compositions are emulsions, either O/W or W/O type, and have all of the aforementioned advantageous properties for the user.

By the term “liquid crystal/gel network” or LCGN with respect to the present invention is meant a combination of water, one or more cationic emulsifiers, one or more low HLB emulsifiers and, optionally, at least one emollient, which, when combined, result in a three-dimensional network consisting of multilamellar bilayers and/or vesicles. The bilayers are oriented in such a way that the hydrocarbon tails are directed toward each other, as are the polar head groups. Hydrophilic molecules reside interlamellarly within the regions between polar head groups. Similarly, lipophilic molecules reside interlamellarly within the regions between hydrocarbon tail groups.

The compositions of the present invention are LCGNs, preferably aqueous, and comprise: water; one or more cationic emulsifiers as primary emulsifiers; one or more low HLB emulsifiers, preferably having an HLB of 1 to about 6 or less, and generally greater than about 1.5, as co-emulsifiers or secondary emulsifiers; wherein the cationic emulsifier(s) and the low HLB emulsifier(s) comprise an emulsifier system capable of forming an LCGN; and one or more emollients, preferably one or more oil phase emollients. The compositions may also or optionally include one or more active agents, adjuvants, or excipients.

In one of its aspects, the present invention encompasses a skin moisturizing composition comprising:

(a) an LCGN comprising:

(i) water;

(ii) one or more cationic emulsifiers;

(iii) one or more low HLB emulsifiers having an HLB of 1 to about 6;

(iv) one or more oil phase emollients; and

(b) optionally, one or more active agents, adjuvants, or excipients, as described hereinbelow; wherein component (b) may form part of the LCGN or may be present as a phase separate and apart from the LCGN.

In another of its aspects, the present invention encompasses a skin moisturizing composition comprising:

(a) an LCGN comprising:

(i) water;

(ii) one or more cationic emulsifiers;

(iii) one or more low HLB emulsifiers having an HLB of 1 to about 6; and

(b) optionally, one or more active agents, adjuvants, or excipients, as described hereinbelow; wherein component (b) may form part of the LCGN or may be present as a phase separate and apart from the LCGN. In this aspect, the one or more low HLB emulsifiers is capable of imparting a degree of emolliency to the skin. Thus, the compositions of this aspect of the present invention can be utilized to formulate a product in which the one or more co-emulsifiers present in the composition provide both a surface active function and an emollient function.

In a preferred embodiment of the present invention, in the composition comprising (iv) one or more oil phase emollients, the emollient is a petroleum-derived or non-petroleum-derived cosmetically acceptable occlusive agent. Mixtures of petroleum-based and non-petroleum-based occlusives are embraced by the compositions of the present invention. Preferred are non-petroleum-derived occlusives.

The compositions according to the present invention provide excellent moisturizing properties with faster absorbency and improved afterfeel characteristics or organoleptics, such as less greasiness, waxiness, and/or drag, following application, when compared with other commercially available compositions. Such commercially available compositions do not contain the LCGN of the present invention and typically contain petrolatum and/or mineral oil, that causes their greasiness and cosmetic unacceptability to the user.

In the compositions of the present invention, the total emulsifier concentration in the composition is typically about 0.1% to about 30%, preferably about 0.25% to about 20%, and more preferably about 0.5% to about 15%. The amount of cationic emulsifier(s) is typically about 0.1% to about 10%, preferably about 0.25% to about 7.5%, and more preferably about 0.5% to about 5%. The amount of low HLB emulsifier(s) is typically about 0.25% to about 20%, preferably about 0.5% to about 15%, more preferably about 1% to about 10%.

All of the percentages of components recited herein are based on the total weight of the composition (i.e., % w/w), unless indicated otherwise.

Water is typically present at about 20% to about 99%, preferably, at about 50% to about 98%, more preferably, about 75% to about 95%.

The ratio of total cationic emulsifier(s) to total low HLB emulsifier(s) is typically between about 1:1 to 1:25, preferably between about 1:1 to 1:10, and more preferably between about 1:1 to 1:5. Most preferred is a ratio of total cationic emulsifier(s) to total low HLB emulsifiers of between about 1:1 to 1:4.

The at least one emollient is typically present in the compositions of the present invention at about 0.25% to about 50%, preferably about 1% to about 35%, and more preferably about 2% to about 20%. For a hand and body lotion, the amount of emollient present in the formulation is typically less than about 15%; for an over-the-counter skin protectant, the amount of emollient in the composition is typically more than about 15%.

The individual components of the composition of the invention will be more specifically discussed individually below.

### EMULSIFIERS

Detailed listings of emulsifying surfactants can be found in McCutcheon's EMULSIFIERS AND DETERGENTS, North America Edition, 1996, McCutcheon Division, MC Publishing Company, the contents of which are incorporated herein by reference. In this section and throughout the application, the nomenclature of the Cosmetic Toiletries and Fragrance Association (CTFA) is generally used in identifying the chemical components. Such nomenclature is standard in these industries, and is employed in the ingredient labeling of such products. See International Cosmetic Ingredient Dictionary, Sixth Edition (1995).

### Cationic Emulsifiers

Cationic emulsifiers that are suitable for use in the compositions of the present invention include, but are not limited to, amidoamines, amine oxides, quaternaries, including ester quaternaries, quaternary salts and ethoxylated quaternary salts, and alkoxylated amines (See, Cationic Surfactants, Surfactant Science Series Volume 4, Marcel Dekker, Inc., New York, 1070).

Nonlimiting examples of amidoamine and amine oxide cationic emulsifiers include stearamidopropyl PG-dimonium chloride phosphate, stearamidopropyl ethyldimonium ethosulfate, stearamidopropyl dimethyl (myristyl acetate) ammonium chloride, stearamidopropyl dimethyl cetearyl ammonium tosylate, stearamidopropyl dimethyl ammonium chloride, stearamidopropyl dimethyl ammonium lactate, behenamine oxide, decylamine oxide, isostearamidopropylamine oxide, myristyl/cetyl amine oxide, oleamine oxide, soyamidopropylamine oxide and stearamidopropylamine oxide.

Nonlimiting examples of quaternary salt cationic emulsifiers comprising bromide and chloride counterions include cetyl ammonium chloride, cetyl ammonium bromide, lauryl ammonium chloride, lauryl ammonium bromide, stearyl ammonium chloride, stearyl ammonium bromide, cetyl dimethyl ammonium chloride, cetyl dimethyl ammonium bromide, lauryl dimethyl ammonium chloride, lauryl dimethyl ammonium bromide, stearyl dimethyl ammonium chloride, stearyl dimethyl ammonium bromide, dimethyl distearyl ammonium chloride, cetyl trimethyl ammonium chloride, cetyl trimethyl ammonium bromide, lauryl trimethyl ammonium chloride, lauryl trimethyl ammonium bromide, stearyl trimethyl ammonium chloride, stearyl trimethyl ammonium bromide, stearyl dimethyl cetyl ditallow dimethyl ammonium chloride, dicetyl ammonium chloride, dicetyl ammonium bromide, dilauryl ammonium chloride, dilauryl ammonium bromide, distearyl ammonium chloride, distearyl ammonium bromide, dicetyl methyl ammonium chloride, dicetyl methyl ammonium bromide, dilauryl methyl ammonium chloride, dilauryl methyl ammonium bromide, distearyl methyl ammonium chloride, distearyl methyl ammonium bromide and mixtures thereof.

Additional quaternary salts include those wherein the C₁₂ to C₂₂ alkyl carbon chain is derived from a tallow fatty acid of from a coconut fatty acid. The term “tallow” refers to an alkyl group derived from tallow fatty acids (usually hydrogenated tallow fatty acids) which generally have mixtures of alkyl chains in the C₁₆ to C₁₈ range. The term “coconut” refers to an alkyl group derived from coconut fatty acids, which generally have mixtures of alkyl chains in the C₁₂ to C₁₄ range. Examples of quaternary salts derived from these tallow and coconut sources include ditallow dimethyl ammonium chloride, ditallow dimethyl ammonium methyl sulfate, di(hydrogenated tallow) dimethyl ammonium chloride, di(hydrogenated tallow) dimethyl ammonium acetate, ditallow dipropyl ammonium phosphate, ditallow dimethyl ammonium nitrate, di(coconutalkyl)dimethyl ammonium chloride, di(coconutalkyl)dimethyl ammonium bromide, tallow ammonium chloride, coconut ammonium chloride, stearamidopropyl PG-dimonium chloride phosphate, stearamidopropyl ethyldimonium ethosulfate, stearamidopropyl dimethyl (myristyl acetate) ammonium chloride, stearamidopropyl dimethyl cetearyl ammonium tosylate, stearamidopropyl dimethyl ammonium chloride, stearamidopropyl dimethyl ammonium lactate and mixtures thereof.

Alkoxylated amines are the alkoxylation products of primary and secondary amines and their salts. Members of the class of alkoxylated amines are represented by structures such as the following:

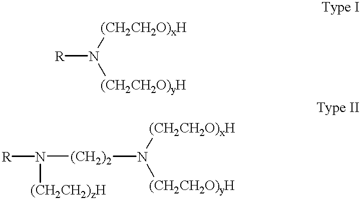

In structures I and II, primary amino groups have been substituted, while a secondary amino group has also been ethoxylated in structure II. R represents an alkyl group having 10 to 22 carbons; the sum of x+y+z indicates the degree of ethoxylation and is greater than 1. (CTFA Scientific/Regulatory Reference CD-Rom 2000, Copyright Cosmetic, Toiletry, and Fragrance Association, 1999, featuring The International Cosmetic Ingredient Dictionary and Handbook, 8th Edition).

Nonlimiting examples of alkoxylated amines include Bis-Hydroxyethyl Cocomonium Nitrate, PEG-5 Cocamine, PEG-15 Cocomonium Chloride, PEG-5 Hydrogenated Tallow Amine, PEG-10 Hydrogenated Tallow Amine, PEG-20 Oleamine, PEG-2 Soyamine, PEG-5 Stearamine, PEG-30 Tallow Amine and Quaternium-82.

Still additional quaternary salt cationic emulsifiers are those ethoxylated quaternary salts including, but not limited to, PEG-2 Coco-Benzonium Chloride, PEG-10 Coco-Benzonium Chloride. PEG-2 Cocomonium Chloride, PEG-15 Cocomonium Chloride, PEG-5 Cocomonium Methosulfate, PEG-9 Diethylmonium Chloride, PEG-25 Diethylmonium Chloride, PEG-2 Dimeadowfoamamidoethylmonium Methosulfate, PEG-3 Dioleoylamidoethylmonium Methosulfate, PEG-5 Ditridecylmonium Chloride, PEG-2 Oleammonium Chloride, PEG-15 Oleammonium Chloride, PEG-8 Palimtoyl Methyl Diethonium Methosulfate, PEG-2 Stearnonium Chloride, PEG-15 Stearmonium Chloride, PEG-5 Stearyl Ammonium Chloride, PEG-5 Stearyl Ammonium Lactate, PEG-10 Stearyl Benzonium Chloride, PEG-20 Tallow Ammonium Ethosulfate, PEG-5 Tallow Benzonium Chloride and PEG-3 Tallow Propylenedimonium Dimethosulfate.

The preferred classes of cationic emulsifiers for use in the present invention are quaternary salts, ethoxylated quaternary salts, and alkoxylated amines. Nonlimiting examples of the most preferred cationic emulsifiers include dimethyl distearyl ammonium chloride (Varisoft TA-100, Witco Chemical), PEG-3 dioleoylamidoethylmonium methosulfate (Incroquat HO-80 PG, Croda Inc.), and quatemium-82 (Stepanquat ML, Stepan). Mixtures of the various suitable cationic emulsifiers can be employed in the compositions of the present invention.

### Low HLB Co-Emulsifiers

Suitable low HLB emulsifiers for use in the compositions of the present invention include, but are not limited to, nonionic surface active agents (surfactants) as described below. As mentioned above, in an aspect of the present invention, the low HLB co-emulsifier can also impart a degree of emolliency to the skin. Accordingly, in such instances, the low HLB emulsifiers may provide both emollient and surface active functions in the compositions and formulations of the present invention.

The nonionic co-emulsifiers useful in the compositions of the present invention include any of the well-known nonionic surface active agents that have an HLB of 1 to about 6, and generally greater than about 1.5. The HLB system is well known in the art and is described in detail in the “The HLB System, A Time-Saving Guide to Emulsifier Selection”, ICI Americas Inc., August 1984, the contents of which are incorporated herein by reference.

The types of low HLB nonionic co-emulsifiers for use in the present compositions are not particularly limited. Preferably, the co-emulsifier is a solid at room temperature (i.e., about 25° C.). Examples of nonionic low HLB co-emulsifiers capable of forming gel networks include, but are not limited to:

1. Fatty acids and fatty alcohols, including the ethoxylated derivatives thereof.

2. Fatty acid esters, like glyceryl monostearate and similar glyceryl esters, sorbitan fatty acid esters, like sorbitan palmitate, solid polyglyceryl fatty acid esters, and solid methyl glucoside fatty acid esters.

3. Fatty alcohol ethers. Ethoxylated or propoxylated fatty alcohols of 10 to 22 carbon atoms include the lauryl, cetyl, stearyl, isostearyl, oleyl, and cholesterol alcohols having attached thereto from 1 to 25 ethylene oxide or propylene oxide groups.

4. Ether-esters such as fatty acid esters of ethoxylated fatty alcohols.

5. Ethoxylated glycerides, such as ethoxylated glyceryl monostearate.

6. Acetoglyceride esters, such as acetylated monoglycerides.

7. Ethylene glycol mono and di-fatty acid esters, and diethylene glycol mono- and di-fatty acid esters.

8. Beeswax derivatives, e.g., polyoxyethylene sorbitol beeswax. These are reaction products of beeswax with ethoxylated sorbitol of varying ethylene oxide content, forming a mixture of ether-esters.

9. Lanolin derivatives, e.g., lanolin alcohols, lanolin fatty acids, ethoxylated lanolins.

10. Amides such as fatty acid amides, ethoxylated fatty acid amides, solid fatty acid alkanolamides.

The “fatty” constituents described, above unless otherwise stated, have a fatty acid residue having from about 8 to 30 carbons, preferably 12 to 22 carbons, and may be saturated or unsaturated.

Other examples of specific nonionic co-emulsifiers include abietic acid, arachidic acid, arachidonic acid, beheneth-5, behenic acid, C₁₈₋₃₆ acid, C₉₋₁₁ pareths, C₁₁₋₁₅ pareths, C₁₁₋₁₅ pareths oleate, C₁₁₋₂₁ pareths, C₁₂₋₁₃ pareth-3, C₁₂₋₁₅ pareth-2, capric acid, caproic acid, caprylic acid, ceteareths, cetearyl alcohol, ceteths, cetyl alcohol, coconut acid, coconut alcohol, corn acid, cottonseed acid, dodoxynol-5, glyceryl behenate, glyceryl caprate, glyceryl caprylate, glyceryl caprylate/caprate, glyceryl cocoate, glyceryl erucate, glyceryl hydroxystearate, glyceryl isostearate, glyceryl lanolate, glyceryl laurate, glyceryl linoleate, glyceryl myristate, glyceryl oleate, glyceryl palmitate lactate, glyceryl sesquioleate, glyceryl stearate, glyceryl stearate citrate, glyceryl stearate lactate, glycol distearate, glycol hydroxystearate, glycol oleate, glycol ricinoleate, glycol stearate, hydrogenated animal glyceride, hydrogenated coconut acid, hydrogenated cottonseed glyceride, hydrogenated lard glyceride, hydrogenated manhaden acid, hydrogenated palm oil glyceride, hydrogenated tallow glyceride, hydrogenated vegetable glyceride, hydroxystearic acid, isodeceth-5, isolaureth-3, isosteareth-2, isosteareth-3, isostearic acid, laneth-5, lanolin acid, lard glyceride, laureth-5 carboxylic acid, lauric acid, linoleic acid, linoleic acid, linseed acid, methyl glycol sesquioleate, methyl glucose sesquistearate, myreth-3, myreth-4, myristic acid, nonoxynols, nonyl nonoxynol-5, octoxyglyceryl behenate, octoxyglyceryl palmitate, octoxynols, oleic acid, oleths, oleyl alcohol, palmitic acid, palm kernel alcohol, palm oil glyceride, PEG-2 oleate through PEG-5 oleate, pelargonic acid, polyglyceryl-2 diisostearate, polyglyceryl-3 oleate, polyglyceryl-4 oleate, propylene glycol isostearate, propylene glycol hydroxystearate, propylene glycol laurate, propylene glycol myristate, propylene glycol oleate, propylene glycol ricinoleate, propylene glycol stearate, ricinoleic acid, sorbitan diisostearate, sorbitan dioleate, sorbitan isostearate, sorbitan laurate, sorbitan oleate, sorbitan palmitate, sorbitan sesquiisostearate, sorbitan sesquioleate, sorbitan sesquistearate, sorbitan stearate, sorbitan triisostearate, sorbitan trioleate, sorbitan tristearate, soy acid, steareths, stearic acid, sucrose cocoate, sucrose laurate, sucrose stearate, tall oil acid, tallow acid, trideceth-3, undecanoic acid, undecylenic acid, and mixtures thereof.

Numerous other useable fatty alcohols and glyceryl esters are listed in the CTFA Cosmetic Ingredient Handbook, First Ed., The Cosmetic Toiletry and Fragrance Assn., Inc., Washington, D.C. (1988) at pages 28 and 29, the contents of which are incorporated herein by reference.

Glyceryl esters, fatty acids and fatty alcohols are preferred low HLB nonionic emulsifiers for use herein. Examples of such preferred emulsifiers are behenyl alcohol (HLB 1.9), glyceryl monostearate (HLB 3.4), and stearic acid (HLB 3.2).

Glycerol monostearate (glyceryl stearate), or GMS as it is commonly called, is a most preferred glyceryl ester. While called “monostearates”, the monoglycerides, formed by the reaction of glycerin with the appropriate fatty acids, are mixtures of α- and β-monoglycerides, 1,2-and 1,3-diglycerides and some unreacted free fatty acid and glycerin. The surface-active properties are attributed to the monoglyceride, with the diglyceride and triglycerides being practically devoid of surface activity. Many grades of GMS are available in the market place which vary in the grade of stearic acid used or in the ratio of mono-, di-, and triester present.

The fatty acids are preferably long chain fatty acids preferably containing 6 to 60 carbon atoms, preferably 8 to 40 carbon atoms, more preferably 12 to 22 carbon atoms. The fatty acids can be saturated or unsaturated. Specific examples include stearic acid, palmitic acid, lauric acid, myristic acid, isostearic acid, hydroxystearic acid, oleic acid, linoleic, ricinoleic acid, arachidic acid, behenic acid, erucic acid and the like.

The fatty alcohols act as emollients as well as help in providing the formation of the LCGN. The fatty alcohols are preferably long chain both alcohols preferably containing 6 to 60 carbon atoms, preferably 8 to 40 carbon atoms, more preferably 14 to 22 carbon atoms, even more preferably 10 to 28 carbon atoms. Lauryl, myristyl, cetyl, hexadecyl, stearyl, isostearyl, hydroxystearyl, oleyl, ricinoleyl, behenyl, erucyl, and 2-octyl dodecanol alcohols are examples of satisfactory fatty alcohols.

The alkoxylated derivatives of the various low HLB co-emulsifiers enumerated above have a degree of alkyoxylation sufficient to provide an HLB value as set forth above.

Mixtures of the various suitable low HLB emulsifiers can also be employed in the compositions of the present invention.

### Emollients

Emollients are conventional lipid materials (e.g., oils, fats, and waxes), silicones and hydrocarbons. As used herein, emollients are emollient oils and emollient waxes, which add lubricity to the surface of the skin or provide a smooth feel to the skin, and which do not have significant surface activity. Hence, such emollients do not include a surface active agent as set forth above.

Suitable emollients for use in the compositions of the present invention include, but are not limited to, hydrocarbon oils and waxes, triglyceride esters, and alkyl esters of fatty acids. Preferred emollients include isopropyl palmitate (IPP) and PPG-2 myristyl ether propionate. In general, however, any compatible emollient that yields acceptable aesthetics is encompassed in the compositions of the present invention.

Other emollients are known and can be used in the compositions of this invention. See, e.g., CTFA Cosmetic Ingredient Handbook (1^{st} Edition, 1998) at page 26 (Fats and Oils) and page 49 (Waxes). Examples of classes of other suitable emollients include the following:

1. Hydrocarbon oils and waxes. Examples include mineral oil, petrolatum, paraffin, ceresin, ozokerite, microcrystalline wax, polyethylene, and perhydrosqualene.

2. Silicone oils, such as dimethyl polysiloxanes, methylphenyl polysiloxanes, water-soluble and alcohol-soluble silicone glycol copolymers.

3. Triglyceride esters, for example vegetable and animal fats and oils. Examples include castor oil, safflower oil, almond oil, avocado oil, palm oil, sesame oil, and soybean oil.

4. Lanolin, lanolin oil and lanolin wax.

5. Waxes such as beeswax, and vegetable waxes including camuba and candelilla waxes.

6. Alkyl esters of fatty acids, including methyl, isopropyl, and butyl esters of fatty acids, are particularly useful herein. Examples of other useful alkyl esters include hexyl laurate, isohexyl laurate, isohexyl palmitate, isopropyl palmitate, decyl oleate, isodecyl oleate, hexadecyl stearate, decyl stearate, isopropyl isostearate, diisopropyl adipate, diisohexyl adipate, dihexyldecyl adipate, diisopropyl sebacate, lauryl lactate, myristyl lactate, cetyl lactate, di-isopropyl adipate, isopropyl myristate, isopropyl palmitate, ethyl hexyl palmitate, isodecyl neopentanoate, C₁₂-C₁₅ alcohol benzoate, diethyl hexyl maleate, PPG-14 butyl ether, PPG-15 stearyl ether and PPG-2 myristyl ether propionate.

7. Alkenyl esters of fatty acids having 10 to 20 carbon atoms. Examples thereof include oleyl myristate, oleyl stearate, and oleyl oleate.

Certain emollients are also useful as occlusive agents, that is, agents which retard the evaporation of water from the skin. By blocking evaporative loss, occlusive materials maintain the water content of the skin at a higher level, thereby minimizing drying of the skin. Emollients useful as occlusive agents are generally classed as petroleum-derived and non-petroleum-derived oils or waxes, and are typically identified in the CTFA Cosmetic Ingredient Handbook, First Edition (1988) in each of the following two sections: Skin Conditioning Agents—Emollient and Skin Conditioning Agents—Occlusive, appearing at pages 79-81 and 83-84, respectively, incorporated by reference herein. Occlusive agents not identified in the emollient section of the CTFA Handbook may be incorporated in the compositions of the present invention, barring any incompatibility, but would not be used in arriving at the concentration for the emollient component of the invention as described herein.

The emollient as occlusive agent is optional, but, when present, is incorporated in the composition at a level of from about 0.25% to about 35%, preferably from about 0.5% to about 15%. These concentrations would be included in the determination of the total emollient concentration in the composition.

Examples of petroleum-based and synthetic occlusive agents suitable for use in the compositions of the present invention include, but are not limited to, petrolatum, mineral oil, dimethicone and allantoin. Petrolatum is preferred.

Examples of non-petroleum-based occlusive agents suitable for use in the compositions of the present invention are hydrogenated animal oils, natural and hydrogenated vegetable oils, including, but not limited to, canola oil, borage oil, shea butter, sunflower oil, palm oil, soybean oil, olive oil, safflower oil, and the like. The most preferred non-petroleum derived occlusives are plant or vegetable derived and include canola oil.

### OPTIONAL INGREDIENTS

The following optional ingredients may be incorporated in the composition. Any particular optional ingredient is present in the composition in an amount effective to achieve its functional purpose.

### Thickening Agents

The compositions of the present invention may comprise one or more thickening agents. Combined with the LCGN, the thickener reduces the surface tension of the system at the oil-water interface. By “water soluble or dispersible” as used herein means that the thickening agents are soluble or dispersible in water at a level of at least about 0.10% by weight at 25° C. Preferred are thickeners that are compatible with the cationic emulsifier component of the LCGN composition.

Thickeners are typically present in the compositions of this invention in an amount of about 0.01% to about 10%, preferably about 0.05% to about 7.5%, and more preferably about 0. 10% to about 5%.

A wide variety of thickeners can be employed herein, in particular those selected from the group consisting of crosslinked polyacrylate polymers, alkyl modified hydroxyalkylcellulose polymers, quaternary ammonium hydroxalkyl cellulose polymers, gums, and mixtures thereof. (See “Encyclopedia of Polymer and Thickeners for Cosmetics”, R. Y. Lochhead and W. R. Fron, eds., Cosmetics 7 Toiletries, vol. 108, pp. 95-135 (May 1993), which lists a variety of thickening or gelling agents, and which is incorporated herein by reference in its entirety). U.S. Pat. No. 5,534,265 also discloses thickening agents (termed gelling agents) the disclosure of which is incorporated herein by reference in its entirety.

Preferred thickening agents for use in the compositions of the present invention are those of the Structure Plus class (National Starch), which include acrylates / aminoacrylates copolymer (INCI name: Acrylates/Aminoacrylates/C10-30 Alkyl PEG-20 Itaconate Copolymer).

Other thickening agents include polysaccharides such as cellulose, carboxymethyl hydroxyethylcellulose, cellulose esters such as cellulose acetate propionate, hydroxyethyl cellulose, hydroxypropyl cellulose, hydroxypropyl methylcellulose, methyl hydroxyethylcellulose, microcrystalline cellulose, sodium cellulose sulfate, celluloses modified wherein the hydroxy groups of the cellulose is hydroxyalkylated to form a hydroxyalkylated cellulose which is then further modified with a C₁₀₋₃₀ straight or branched chain alkyl group through an ether linkage and the like.

Other suitable thickening agents include scleroglucans such as Clearogel CS11 from Michel Mercier Products, Inc., Mountainside, N.J.

Gums are also suitable thickening agents for use herein. Nonlimiting examples of gums useful as thickening agents include acacia, agar, algin, alginic acid, ammnonium alginate, amylopectin, calcium alginate, calcium carrageenan, camitine, carrageenan, corn starch, dextrin, gelatin, gellan gum, guar gum, guar hydroxyproplytriammonium chloride, hyaluronic acid, hydrated silicas, hydroxypropyl chitosan, hydroxypropyl guar, karaya gum, kelp, locust bean gum, magnesium aluminum silicate, magnesium trisilicate, natto gum, potassium alginate, potassium carrageenan, propylene glycol alginate, sclerotium gum, tragacanth gum, xanthan gum, and the like.

In addition, polymeric thickeners are suitable for use in the compositions of the present invention, such as those described in U.S. Pat. No. 5,989,536 to Deckner et al. Such thickeners include those selected from the group consisting of crosslinked polyacrylate polymers, alkyl modified hydroxyalkylcellulose polymers, quaternary ammonium hydroxalkyl cellulose polymers, and mixtures thereof.

The crosslinked polyacrylate polymers useful as thickeners include both cationic and nonionic polymers, with the cationics being generally preferred. Examples of useful crosslinked nonionic polyacrylate polymers and crosslinked cationic polyacrylate polymers are those described in U.S. Pat. No. 5,100,660, to Hawe et al., issued Mar. 31, 1992; U.S. Pat. No. 4,849,484, to Heard, issued Jul. 18, 1989; U.S. Pat. No. 4,835,206, to Farrar et al., issued May 30, 1989; U.S. Pat. No. 4,628,078 to Glover et al. issued Dec. 9, 1986; U.S. Pat. No. 4,599,379 to Flesher et al. issued Jul. 8, 1986; EP 228,868, to Farrar et al., published Jul. 15, 1987; and U.S. Pat. No. 5,989,536, issued to G. Deckner et al., issued Nov. 23, 1999, all of which are incorporated by reference herein in their entirety.

Nonlimiting examples of suitable crosslinking agents for use in the crosslinked polyacrylate polymers include those selected from the group consisting of methylenebisacrylamides, diallyldialkyl ammonium halides, polyalkenyl polyethers of polyhydric alcohols, allyl acrylates, vinyloxyalkylacrylates, and polyfunctional vinylidenes. Specific examples of such useful crosslinking agents include those selected from the group consisting of methylenebisacrylamide, ethylene glycol di-(meth)acrylate, di-(meth)acrylamide, cyanomethylacrylate, vinyloxyethylacrylate, vinyloxyethylmethacrylate, allyl pentaerythritol, trimethylolpropane diallylether, allyl sucrose, butadiene, isoprene, divinyl benzene, divinyl naphthalene, ethyl vinyl ether, methyl vinyl ether, and allyl acrylate. Other crosslinkers include formaldehyde and glyoxal.

Other cationic polymers useful herein, are those not containing acrylamide or other monomers. In this instance the polymer is essentially a homopolymer of a dialkylaminoalkyl methacrylate monomer or its quaternary ammonium or acid addition salt. The dialkylaminoalkyl methacrylate polymers preferably contain a crosslinking agent as described above.

Alkyl hydroxyalkylcellulose ethers are additional thickening agents that can be utilized in the compositions of this invention. By the term “alkyl hydroxyalkylcellulose ethers” as used herein is meant polymers containing a cellulose backbone, i.e. a polysaccharaide backbone of repeating glucose units. In these polymers, the hydroxy groups of the cellulose polymer are hydroyxalkylated (preferably hydroxyethylated or hydroxypropylated) to form a hydroxyalkylated cellulose which is then further modified with a C₁₀-C₃₀ straight chain or branched chain alkyl group through an ether linkage. Typically these polymers are ethers of C₁₀-C₃₀ straight or branched chain alcohols with hydroxyalkylcelluloses. Examples of suitable alkyl groups for these compounds include those selected from the group consisting of stearyl, isostearyl, lauryl, myristyl, cetyl, isocetyl, cocoyl (i.e. alkyl groups derived from the alcohols of coconut oil), palmityl, oleyl, linoleyl, linolenyl, ricinoleyl, behenyl, and mixtures thereof. Preferred among the alkyl hydroxyalkyl cellulose ethers is the material given the CTFA designation cetyl hydroxyethylcellulose, which is the ether of cetyl alcohol and hydroxyethylcellulose, sold under the tradename Natrosol CS Plus from Aqualon Corporation.

Also suitable are nonionic amphiphilic polymers identified in U.S. Pat. No. 6,010,541, incorporated by reference herein. In particular, nonionic polyether polyurethane polymers sold under the tradename Aculyn 44 and Aculyn 46 may be useful. Other polymeric thickeners that could be used in accordance with the present invention are copolymers of C₁₀-C₃₀ alkyl acrylates and one or more monomers of acrylic acid and methacrylic acid or their simple esters, e.g., with Pemulen TR-1 sold by Goodrich, and copolymers of two or more monomers of acrylic acid and methacrylic acid and their simple esters, e.g., copolymers sold under the tradename Salcare by Alloid Colloids. Anionic polymers such as Aculyn 22, Aculyn 28 and Aculyn 33 may also be used. These are available from Rohm & Haas and are identified in the CTFA Scientific/Regulatory Reference CD-Rom 2000, Copyright Cosmetic, Toiletry, and Fragrance Association, 1999, featuring The International Cosmetic Ingredient Dictionary and Handbook, 8th Edition, incorporated herein by reference.

Another class of thickeners suitable for formulating into the compositions of the present invention include the quaternary ammonium hydroxyalkylcellulose polymers. By the term “quaternary ammonium hydroxyalkylcellulose polymer” as used herein is meant polymers containing a cellulose backbone, i.e. a polysaccharaide backbone of repeating glucose units. In these polymers, the hydroxy groups of the cellulose polymer are hydroxyalkylated (preferably hydroxyethylated or hydroxypropylated) to form a hydroxyalkylated cellulose which is then further modified with a cationic quaternary ammonium or protonated ammonium group.

Commercially available cationic modified celluloses include: CTFA designated polyquaternium-24, which is the quaternary ammonium salt of hydroxyethyl cellulose reacted with a lauryl dimethyl ammonium substituted epoxide, sold under the tradename Quatrisoft Polymer LM-200 and available from Amerchol Corporation. Other commercially available cationic modified celluloses include laurdimonium hydroxyethyl cellulose, steardimonium hydroxyethyl cellulose and cocodimonium hydroxyethyl cellulose. These three materials are known by the trade names Crodacel QL, Crodacel QS, and Crodacel QM, respectively, and are all commercially available from Croda Corp. Another highly useful cationic cellulose is laurdimonium hydroxypropyl oxyethyl cellulose, which is commercially available as Crodacel QL Special, from Croda Corp. Polyquaternium 24 is preferred among the quaternary ammonium hydroxyalkyl cellulose polymers.

### Optional Active Agents, Adiuvants and Excipients

The compositions of the present invention optionally contain other ingredients suitable for use in a skin moisturizer formulation:

### Humectants

Humectants are examples of other optional ingredients that can be formulated in the compositions of the present invention. A variety of humectants can be employed and can be present in an amount of from about 1% to about 30%, preferably about 2% to about 25%, and more preferably about 3% to about 20% of the total formulation weight.

Suitable humectant materials include polyhydroxy alcohols such as sorbitol, glycerin, hexanetriol, propylene glycol, hexylene glycol, and the like; polyethylene glycol; sugars and starches; sugar and starch derivatives such as alkoxylated glucose and the like; D-panthenol; hyaluronic acid; lactamide monoethanolamine; acetamide monoethanolamine; 2-pyrrolidone-5-carboxylic acid and mixtures thereof. Especially preferred is glycerin. Other useful humectants include glucosides, lactamide monoethanolamine, and acetamide monoethanolamine. Most preferred are glycerin, propylene glycol, and urea.

Other ingredients optionally present in the compositions of the present invention include preservatives such as methylparaben; chelating agents such as tetrasodium ethylene diamine tetraacetic acid, and the like; herb blends; fragrances; ceramides; colorants; sunscreens, vitamins; antioxidants, antiinflammatories; defoamers; alpha hydroxy acids; excipients; neutralizing agents; and the like. For formulating the compositions of the present invention, preservatives are typically present in an amount of about 0.01% to about 2%; chelators are typically present in an amount of about 0.01% to about 0.25%; defoamers are typically present in an amount of about 0.01% to about 1%; and neutralizing ingredients are typically present in an amount of about 0.01% to about 0.5%.

### Preparation of Compositions of the Present Invention

The compositions of the present invention are typically prepared by premixing the water soluble or water dispersible ingredients, including the cationic emulsifier(s), with water with agitation and heated for a time and temperature sufficient to form a substantially homogenous water phase. Typically, sufficient mixing and heating of the water phase is achieved at a temperature of about 65° C. to about 80° C.; preferably at a temperature of about 70° C. to about 75° C.

In a separate container the lipophilic ingredients, including the low HLB co-emulsifier, are mixed for a time and temperature sufficient to form a substantially homogenous oil phase. Typically, mixing and heating of the oil phase is performed at the same or slightly higher temperatures as for the water phase. A wide variety of oil type and emollient type materials and mixtures of materials are suitable for use in the oil phase of the compositions of the present invention. Typically, the oil phase includes hydrocarbons, fatty acids, phospholipids, fatty alcohols, other emollients, other fatty acid derivatives, cholesterol or cholesterol derivatives, ceramides, vegetable oils, vegetable oil derivatives, and the like. The oil phase is then emulsified into the water phase using a standard mixing apparatus such as a homogenizing mill or the like. The resulting mixture is then cooled during which time the LCGN is formed. Optional active agents/excipients/adjuvants such as sunscreens, antioxidants, thickeners, fragrances, preservatives, herbal blends, colorants, and the like are added before or after the LCGN is formed, depending on their sensitivity to temperature and final desired location within emulsion.

In cases where an ingredient cannot be incorporated easily into the LCGN, for example, a lipophilic material such as a sunscreen or a hydrophilic material, the optional ingredient can be incorporated into the oil or water phase, as the case may be, or during homogenization, provided that such ingredient(s) are not heat sensitive.

### EXAMPLES

The following examples are to illustrate the invention but should not be interpreted as a limitation thereon.

### Example 1

The formulations of the compositions provided in this example were prepared according to the techniques described herein and have the following components:

Composition 1

| Ingredients | Percent Weight |
|---|---|
| Water | qs to 100 |
| Distearyldimonium Chloride | 2.40 |
| Glycerin | 15.00 |
| Behenyl Alcohol | 3.93 |
| Glyceryl Monostearate | 2.20 |
| PPG-2 Myristyl Ether Propionate | 6.50 |
| Canola Oil | 4.00 |
| Preservative | 0.60 |
| Thickener | 1.00 |
| Fragrance | 0.40 |
| Dimethicone | 0.10 |

Composition 2

| Ingredients | Percent Weight |
|---|---|
| Water | qs to 100 |
| Quaternium-82 | 1.65 |
| Glycerin | 8.50 |
| PEG-100 Stearate | 1.40 |
| Stearyl Alcohol | 2.45 |
| Cetyl Alcohol | 1.20 |
| Glyceryl Monostearate | 1.50 |
| Isopropyl Palmitate | 7.00 |
| Hydrogenated Vegetable Oil | 5.00 |
| Preservative | 0.60 |
| Thickener | 1.00 |
| Fragrance | 0.20 |
| Dimethicone | 0.10 |

Composition 3

| Ingredients | Percent Weight |
|---|---|
| Water | qs to 100 |
| PEG-3 Dioleoylamidoethylmonium | 3.00 |
| Methosulfate | |
| Glycerin | 12.50 |
| Behenyl Alcohol | 4.20 |
| Glyceryl Mono stearate | 2.10 |
| Stearic Acid | 0.70 |
| PPG-2 Methyl Ether Propionate | 8.00 |
| Petrolatum | 3.00 |
| Preservative | 0.60 |
| Thickener | 1.00 |
| Fragrance | 0.50 |
| Dimethicone | 0.20 |

Composition 4

| Ingredients | Percent Weight |
|---|---|
| Water | qs to 100 |
| Stearamidopropyl Dimethyl Ammonium | 2.00 |
| Chloride | |
| Glycerin | 6.50 |
| Behenyl Alcohol | 3.20 |
| Glyceryl Monostearate | 2.10 |
| Stearic Acid | 1.70 |
| Isopropyl Myristate | 7.00 |
| Preservative | 0.70 |
| Thickener | 0.25 |
| Fragrance | 0.50 |
| Dimethicone | 0.30 |

Composition 5

| Ingredients | Percent Weight |
|---|---|
| Water | qs to 100 |
| PEG Dioleoylamidoethylmonium | 3.00 |
| Methosulfate | |
| Propylene Glycol | 2.00 |
| Glycerin | 8.50 |
| Stearyl Alcohol | 3.00 |
| Cetyl Alcohol | 1.50 |
| Glyceryl Monostearate | 3.00 |
| Octyl Isononanoate | 5.00 |
| Preservative | 0.75 |
| Thickener | 2.00 |
| Fragrance | 0.20 |

### Example 2

Example 2 describes the process for preparing the formulation of exemplary Composition 1 according to the present invention. In a suitable vessel the water, distearyldimonium chloride, glycerin, and thickener were mixed and heated to 75° C. to 80° C. with stirring. In a separate vessel the behenyl alcohol, glyceryl monostearate, PPG-2 myristyl ether propionate, canola oil and dimethicone were mixed and heated to 75-80° C. to form an oil phase. The oil phase was then emulsified into the water-containing mixture using a homogenizing mill. The batch was then cooled, with stirring, to 40° C., during which time the LCGN was formed, at which time the preservative and fragrance ingredients were added.

All patent applications, patents, texts, CDRom information and literature references cited in this specification are hereby incorporated by reference in their entirety to more fully describe the state of the art to which the present invention pertains.

What is claimed is:

1. A skin moisturizer composition comprising a liquid crystal gel network comprising:
(a) water,
(b) at least one cationic emulsifier, and
(c) at least one low HLB coemulsifier having a hydrophilic lipophilic balance (HLB) of 1 to about 6 or less;
wherein the ratio of (b) to (c) is from about 1:1 to 1:25; and further wherein the at least one low HLB coemulsifier is capable of imparting emolliency to the skin.

2. A skin moisturizer composition comprising a liquid crystal gel network comprising:
(a) water,
(b) at least one cationic emulsifier,
(c) at least one low HLB coemulsifier having a hydrophilic lipophilic balance (HLB) of 1 to about 6 or less;
wherein the ratio of (b) to (c) is from about 1:1 to 1:25; and
(d) at least one emollient.

3. The composition according to claim 2, wherein the emollient component (d) comprises at least one occlusive agent.

4. The composition according to claim 1 or claim 2, wherein the ratio of component (b) to component (c) is from about 1:1 to 1:10.

5. The composition according to claim 1 or claim 2, wherein the ratio of component (b) to component (c) is from about 1:1 to 1:5.

6. The composition according to any one of claims 1, 2 or 4, wherein the cationic emulsifier is selected from the group consisting of amidoamines, alkoxylated amines, amine oxides and quaternaries selected from the group consisting of ester quaternaries, quaternary salts and ethoxylated quaternary salts.

7. The composition according to any of claims 1, 2, or 4, wherein the cationic emulsifier is selected from the group consisting of quatemium-82, PEG-3 dioleoylamidoethylmonium methosulfate, dimethyl distearyl ammonium chloride and mixtures thereof.

8. The composition according to any of claims 1, 2, or 4, wherein the low HLB emulsifier is selected from the group consisting of fatty acids, fatty alcohols, fatty acid esters, fatty alcohol ethers, ethoxylated glycerides, acetoglyceride esters, ethyleneglycol mono- and di-fatty acid esters, fatty acid amides and mixtures thereof.

9. The composition according to claim 2, wherein the low HLB emulsifier is selected from the group consisting of behenyl alcohol, glyceryl monostearate, stearic acid and mixtures thereof.

10. The composition according to claim 3, wherein the emollient comprises an occlusive agent selected from the group consisting of petrolatum, mineral oil, silicone and allantoin.

11. The composition according to claim 3, wherein the emollient comprises an occlusive agent selected from the group consisting of canola oil, hydrogenated vegetable oil, borage oil, shea butter and sunflower oil.

12. The composition according to claim 11, wherein the occlusive agent is canola oil.

13. The composition according to claim 2, wherein the emollient oil/wax is selected from the group consisting of hydrocarbon oils and waxes, triglyceride esters, and alkyl esters of fatty acids.

14. The composition according to claim 13, wherein the emollient oil/wax is isopropyl palmitate or PPG-2 myristyl ether propionate.

15. The composition according to claim 1 or claim 2, wherein the at least one cationic emulsifier is present in the composition in an amount of about 0. 1% to about 10%, by weight of the total composition.

16. The composition according to claim 15, wherein the at least one cationic emulsifier is present in an amount of 0.25% to 7.5% by weight of the total composition.

17. The composition according to claim 1 or claim 2, wherein the at least one low HLB emulsifier is present in an amount of from about 0.25% to 20% by weight of the total composition.

18. The composition according to claim 17, wherein the at least one low HLB emulsifier is present in an amount of from about 0.5% to 15% by weight of the total composition.

19. The composition according to claim 2, wherein the emollient is present in an amount of from about 0.25% to 50% by weight of the total composition.

20. The composition according to claim 19, wherein the emollient is present in an amount of from about 1.0% to 35% by weight of the total composition.

21. The composition according to any of claims 1, 2 or 4, wherein water is present in an amount of from about 20% to 99% by weight of the total composition.

22. The composition according to claim 1 or claim 2, further comprising one or more additive components selected from the group consisting of active agents, adjuvants and excipients.

23. The composition according to claim 22, wherein the one or more additive components is a humectant or a thickening agent.
